(19) United States
(12) Patent Application Publication
(10) Pub. No.: US 2024/0031019 A1
(43) Pub. Date: Jan. 25, 2024

(54) MONITORING DEVICE AND OPTICAL FIBER IDENTIFICATION METHOD

(71) Applicant: NIPPON TELEGRAPH AND TELEPHONE CORPORATION, Tokyo (JP)

(72) Inventors: Hidenobu HIROTA, Musashino-shi, Tokyo (JP); Takui UEMATSU, Musashino-shi, Tokyo (JP); Hiroyuki IIDA, Musashino-shi, Tokyo (JP); Kazutaka NOTO, Musashino-shi, Tokyo (JP); Kenji INOUE, Musashino-shi, Tokyo (JP)

(73) Assignee: NIPPON TELEGRAPH AND TELEPHONE CORPORATION, Tokyo (JP)

(21) Appl. No.: 18/028,907

(22) PCT Filed: Oct. 14, 2020
(86) PCT No.: PCT/JP2020/038826

§ 371 Date: Mar. 28, 2023

(51) Int. Cl. H04B 10/07; H04B 10/25; H04B 10/272

(52) U.S. Cl. CPC H04B 10/07; H04B 10/25; H04B 10/272

(57) ABSTRACT

An object of the present invention is to provide a monitoring device and an optical fiber identification method capable of efficiently identifying an optical fiber at a construction site.

The monitoring device 71 includes a light receiver 74 that receives an optical signal SL leaked from an optical fiber, a counter 75 that counts the number of unique numbers indicating transmission sources included in the optical signal SL, and a display unit 76 that displays the number of unique numbers. The monitoring device 71 further includes a control unit 77 that causes the display unit 76 to display that a portion where the optical signal SL has leaked is between the 8-branch splitter 51 and the OLT 11 when the number of unique numbers is two or more, and that causes the display unit 76 to display that it is unknown whether a portion where the optical signal SL has leaked is between the 8-branch splitter 51 and the OLT 11 or between the 8-branch splitter 51 and the ONU 21 when the number of unique numbers is one.

### TECHNICAL FIELD

The present disclosure relates to a monitoring device and an optical fiber identification method for identifying a position of an optical fiber included in an optical network.

### BACKGROUND ART

FIG. 1 is a diagram illustrating a configuration of an optical network. In the optical network, the facilities shown in FIG. 1 are laid to provide the Internet and telephone services to a user. The laid facilities include an optical line terminal (OLT) 11 which is a communication device installed in a communication building, and an optical network unit (ONU) 21 installed in a user's house 20. The OLT 11 and the ONU 21 are connected by using an integrated distribution module (IDM) 12, an optical cable 50, and an 8-branch splitter 51 (the number of branches is arbitrary, in this example, 8 branches will be described). As communication light, the OLT 11 outputs a wavelength of 1490 nm or 1550 nm, and the ONU 21 outputs a wavelength of 1310 nm. The OLT 11 and the ONU 21 recognize each other and provide a high-speed broadband service such as the Internet and a telephone to a user.

In recent years, the competition between services has become vigorous, and a user sometimes replaces a service with that of another company. When the service of the user is stopped, it is necessary to perform the operation of removing a part of the facilities. Specifically, the operation is a first operation of cutting and removing an optical fiber 60 connecting the 8-branch splitter 51 and the ONU 21, and a second operation of removing the ONU 21 installed in the user's house.

FIG. 2 is a diagram illustrating a place where the first operation is performed. A closure 52 is provided on the side of a utility pole 55. The optical fiber 60 comes out from the closure 52 and extends to the user's house 20. The operator goes up to the utility pole 55, opens the box of the closure 52, and performs operation.

FIG. 3 illustrates the wiring inside the closure 52. A large number of 8-branch splitters 51 are installed in one closure 52. The number of optical fibers connected to one 8-branch splitter 51 is nine. The details are eight optical fibers from the 8-branch splitter 51 to the user's house 20, and one optical fiber in the optical cable 50 connecting the 8-branch splitter 51 to a communication building 10. If one 8-branch splitter 51 is disposed in the closure 52, nine optical fibers are wired, and if two 8-branch splitters are disposed, 18 optical fibers are wired.

FIG. 4 is a diagram illustrating the inside of the closure 52. The closure 52 has a multi-stage tray 53 for accommodating the 8-branch splitter 51. An optical fiber connected to the 8-branch splitter 51 is housed in the space of a frame 54. When the number of 8-branch splitters 51 to be accommodated is small, the number of optical fibers accommodated in the frame 54 is also small, and the optical fibers can be easily identified. However, when the 8-branch splitters 51 are accommodated in all the trays 53, the number of optical fibers increases, and the optical fibers are densely disposed in the space of the frame 54, making it difficult to identify the optical fibers. In other words, there is a likelihood that an operator will select and perform operations on an erroneous optical fiber and that an erroneous construction will occur.

For this reason, a method for identifying an optical fiber as shown in FIG. 5 is introduced (see, for example, NPL 1). A wavelength of 1650 nm different from a wavelength for communication is used for test light TL for identifying the optical fiber. A wavelength of 1650 nm is hereinafter referred to as a “test wavelength.” By changing the wavelength of the test light TL to the wavelength for communication, the communication is not affected. The test light TL is emitted from the communication building 10. It is known that when the optical fiber is bent, light propagating through the core of the optical fiber leaks. Therefore, when a bending portion R1 is given to the optical fiber between the communication building 10 and the 8-branch splitter 51, the test light TL leaks out, and thus the optical fiber can be identified.

On the other hand, between the 8-branch splitter and the ONU 21, the test light TL is distributed by the 8-branch splitter, and the test light TL propagates to all the eight optical fibers. Therefore, when bending R2 is given to the optical fiber between the 8-branch splitter and the ONU 21, the test light TL leaks from any of the eight optical fibers. Therefore, the method disclosed in NPL 1 cannot identify an optical fiber between the 8-branch splitter and the ONU.

For this reason, a method for identifying an optical fiber as shown in FIG. 6 is introduced (see, for example, NPL 2). An optical signal is output from the ONU 21, and the optical signal includes a MAC address. The MAC address is a number allocated to the ONU 21, and the numbers do not have duplication. Thus, by specifying the number, an optical fiber between the 8-branch splitter 51 and the ONU 21 can be identified.

In order to acquire the MAC address, bending R is given to the optical fiber, and an optical signal from the ONU 21 leaks. The optical signal of the ONU includes transmission data as shown in FIG. 15. In this, the transmission source address is a MAC address. A monitor tool 70 is used to display the MAC address. The monitor tool 70 has a function of receiving a leaked optical signal SL, analyzing the optical signal SL, and displaying the MAC address. Since the MAC address is different for each ONU 21, the optical fiber can be identified.

### CITATION LIST

### Non Patent Literature

[NPL 1] Yoshitaka Enomoto, “Optical core wire contrast device,” Institute of Electronics, Information and Communication Engineers, Knowledge Forest, 5-2-6, P6
[NPL 2] Hidenobu Hirota, Tomohiro Kawano, Makoto Shimpo, Kazuki Nado, Natsuki Honda, Takanori Kiyokura, and Tetsuya Manabe, “Monitoring of ONU upstream light using side light output technology,” Institute of Electronics, Information and Communication Engineers Japanese Journal B, Vol. J100-B, No. 4, pp. 315-325, 2017.

### SUMMARY OF INVENTION

### Technical Problem

As described above, when the user stops the service, it is necessary to perform the first operation and the second operation. In the first operation, the operation of removing the optical fiber in the closure is included. As described with reference to FIG. 4, optical fibers are densely disposed in the closure, and it is conceivable that an operator may make a mistake regarding the optical fiber to be cut. For example, when an operator cuts an optical fiber between the OLT 11 and the 8-branch splitter 51 by mistake, the service to the eight ONUs 21 is stopped at the maximum.

In order to avoid the mistake, it is necessary to identify the optical fiber to be cut by the methods disclosed in NPL 1 and 2. However, it is inefficient for the operator to work in the two methods disclosed in NPL 1 and 2 at the construction site. In other words, the method disclosed by NPL has a problem that it is difficult to perform the operation efficiently.

Therefore, an object of the present invention is to provide a monitoring device and an optical fiber identification method capable of efficiently identifying an optical fiber at a construction site in order to solve the above-mentioned problem.

### Solution to Problem

In order to achieve the above object, a monitoring device according to the present invention displays the number of unique numbers of an ONU included in an optical signal leaked from a bending portion.

Specifically, a monitoring device according to the present invention includes a light receiver that receives an optical signal leaked from an optical fiber, a counter that counts the number of unique numbers indicating transmission sources included in the optical signal, and a display unit that displays the number of unique numbers.

Further, an optical fiber identification method according to the present invention includes receiving an optical signal leaked from an optical fiber, counting the number of unique numbers indicating transmission sources included in the optical signal, and displaying the number of unique numbers on a display unit.

For example, in the optical network as shown in FIG. 1, an uplink optical signal between the ONU 21 and the 8-branch splitter 51 is only the signal transmitted by the ONU 21, and the unique number (MAC address and the like) of the ONU included in the optical signal is only a single one. On the other hand, an uplink optical signal between the OLT 11 and the 8-branch splitter 51 includes an uplink optical signal transmitted by a maximum of eight ONUS 21, and there are one or more unique numbers (MAC addresses and the like) of the ONUS included in the optical signal.

That is, the operator simply checks the number of unique numbers displayed on the monitoring device, and can determine whether the optical fiber to be cut is between the ONU 21 and the 8-branch splitter 51 or between the OLT 11 and the 8-branch splitter 51. Accordingly, the present invention can provide a monitoring device and an optical fiber identification method capable of efficiently identifying an optical fiber at a construction site.

When the optical network is a passive optical network (PON), the light receiver of the monitoring device according to the present invention may receive the optical signal transmitted by the ONU, and the monitoring device may further include a control unit that
causes the display unit to display that a portion where the optical signal has leaked is between the optical splitter and the OLT when the number of unique numbers is two or more, and that causes the display unit to display that it is unknown whether a portion where the optical signal has leaked is between the optical splitter and the OLT or between the optical splitter and the ONU when the number of unique numbers is one.

Further, the monitoring device according to the present invention may further include a bending imparting portion that forms a bending portion in the optical fiber, the bending portion causing the optical signal to leak from the optical fiber.

The above inventions can be combined wherever possible.

### Advantageous Effects of Invention

The present invention can provide a monitoring device and an optical fiber identification method capable of efficiently identifying an optical fiber at a construction site.

### BRIEF DESCRIPTION OF DRAWINGS

FIG. 1 is a diagram illustrating an optical network.

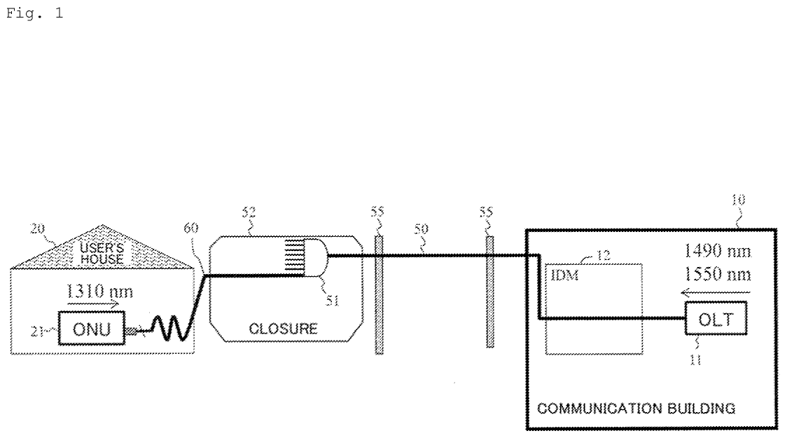

FIG. 2 is a diagram illustrating the appearance of a closure.

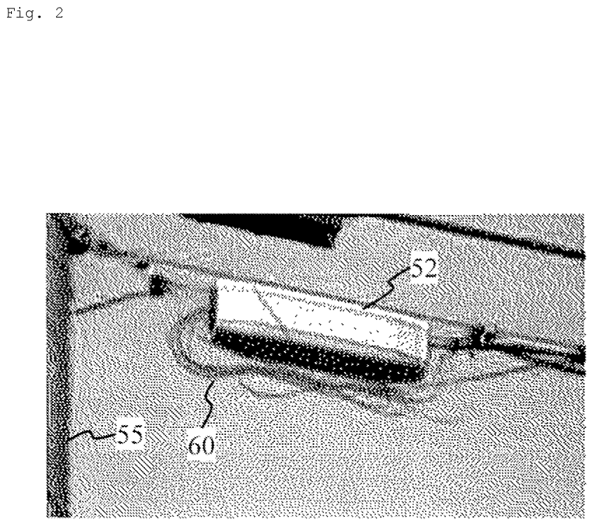

FIG. 3 is a diagram illustrating the inside of the closure.

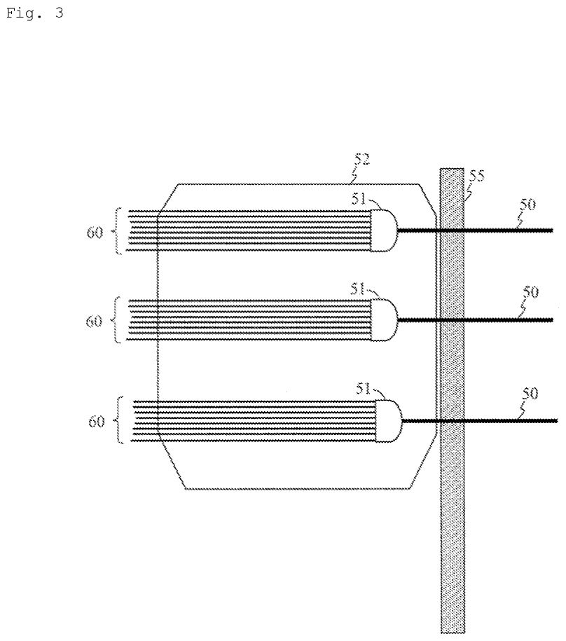

FIG. 4 is a diagram illustrating the inside of the closure.

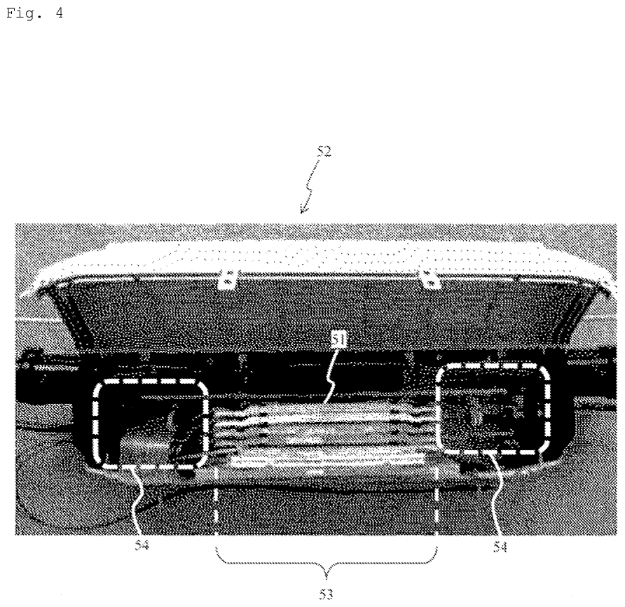

FIG. 5 is a diagram illustrating a method for identifying an optical fiber.

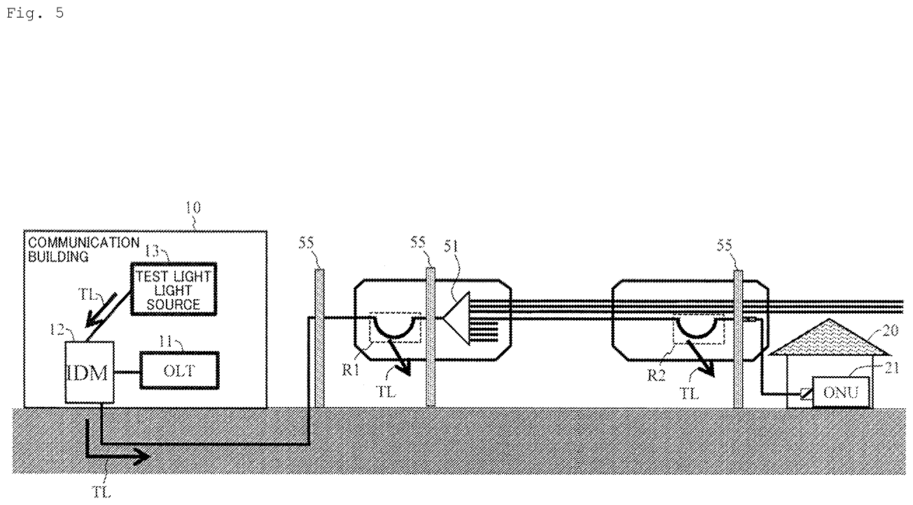

FIG. 6 is a diagram illustrating a method for identifying an optical fiber.

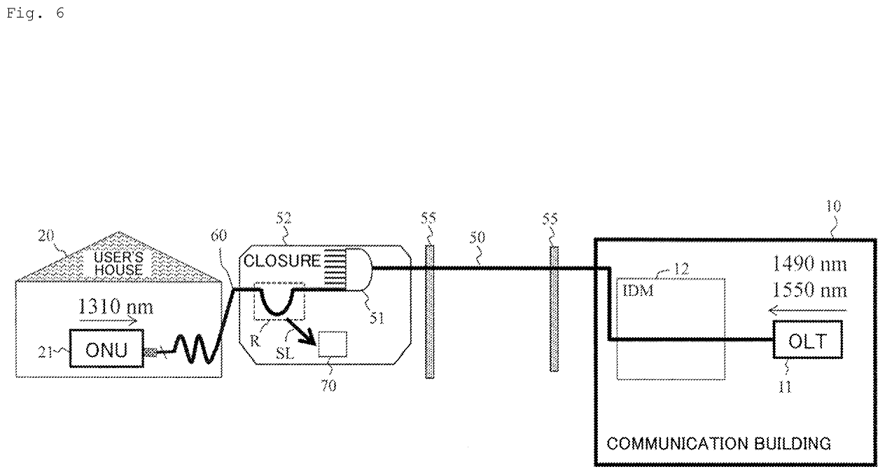

FIG. 7 is a diagram illustrating an operation of identifying an optical fiber performed by using a monitoring device according to the present invention.

FIG. 8 is a display example displayed by a display unit of the monitoring device according to the present invention.

FIG. 9 is a diagram illustrating an operation of identifying an optical fiber performed by using the monitoring device according to the present invention.

FIG. 10 is a display example displayed by the display unit of the monitoring device according to the present invention.

FIG. 11 is a diagram illustrating an operation of identifying an optical fiber performed by using the monitoring device according to the present invention.

FIG. 12 is a display example displayed by the display unit of the monitoring device according to the present invention.

FIG. 13 is a diagram illustrating an optical fiber identification method according to the present invention.

FIG. 14 is a diagram illustrating an optical fiber identification method according to the present invention.

FIG. 15 is a diagram illustrating information included in an optical signal.

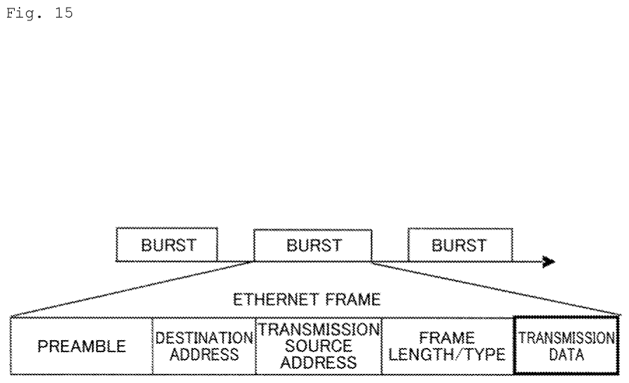

FIG. 16 is a diagram illustrating the monitoring device according to the present invention.

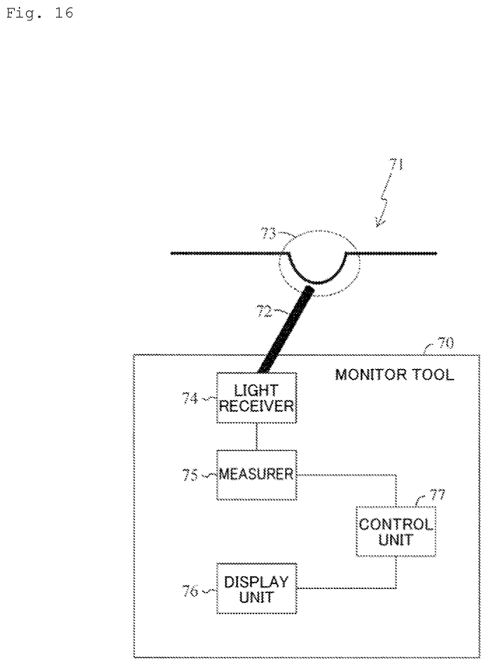

### DESCRIPTION OF EMBODIMENTS

Embodiments of the present invention will be described with reference to the accompanying drawings. The embodiments described below are examples of the present invention, and the present invention is not limited to the following embodiments. Note that, in the present specification and the drawings, the components having the same reference numerals indicate the same components.

### Embodiment 1

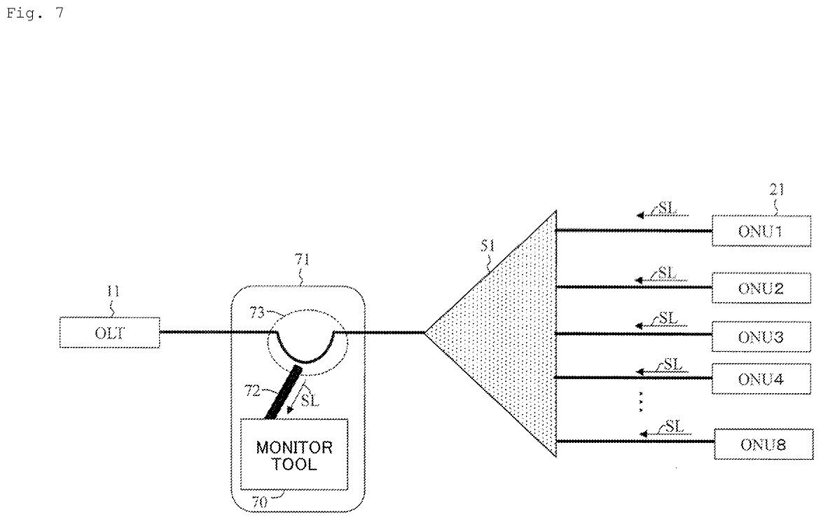

FIG. 7 is a diagram illustrating an optical fiber identification method. In the present embodiment, an optical network in which an OLT 11 and an ONU 21 are connected by an 8-branch splitter 51 will be described. In the present embodiment, eight ONUs 21 are connected to the 8-branch splitter 51.

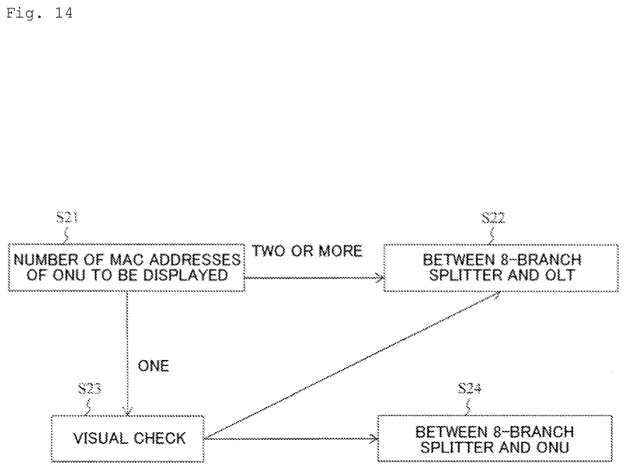

When starting construction, an operator attaches a monitoring device 71 to an optical fiber to be constructed among the optical fibers stored in the closure. FIG. 14 is a diagram illustrating the monitoring device 71. The monitoring device 71 includes a light receiver 74 that receives an optical signal SL leaked from an optical fiber, a counter 75 that counts the number of unique numbers indicating transmission sources included in the optical signal SL, and a display unit 76 that displays the number of unique numbers.

Further, the monitoring device 71 further includes a bending imparting portion 73 that forms a bending portion causing the optical signal SL to leak from the optical fiber in the optical fiber. The bending portion imparting portion 73 bends an optical fiber between the OLT 11 and the 8-branch splitter 51, and extracts the optical signal SL output by the ONU 21 as leaked light. The leaked light is collected by a probe 72 and propagated to a monitor tool 70.

The monitoring device 71 further includes a control unit 77 that causes the display unit 76 to display that a portion where the optical signal SL has leaked is between the optical splitter (8-branch splitter 51) and the OLT 11 when the number of unique numbers (MAC addresses) is two or more, and that causes the display unit 76 to display that it is unknown whether a portion where the optical signal SL has leaked is between the optical splitter (8-branch splitter 51) and the OLT 11 or between the optical splitter (8-branch splitter 51) and the ONU 21 when the number of unique numbers is one.

The monitor tool 70 analyzes the MAC address of the ONU 21 included in the optical signal SL with the measurer 75, and can display the result on the display unit 76. The monitor tool 70 is provided with the control unit 77, and the control unit 77 displays the number of MAC addresses included in the optical signal SL, not a numerical value to which the MAC address is specifically allocated, on the display unit 76. That is, the monitor tool 70 displays the number of ONUs 21 connected to the 8-branch splitter 51.

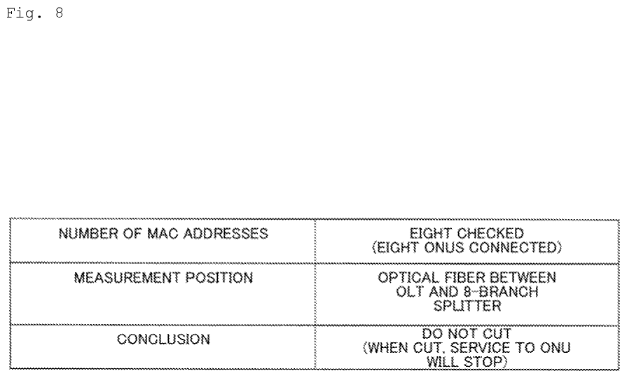

FIG. 8 is a diagram illustrating a display example displayed by the display unit 76. In the present embodiment, eight ONUs 21 are connected to the branch splitter 51, and the optical signal SL received by the light receiver 74 includes eight MAC addresses. Therefore, the display unit 76 performs display as shown in FIG. 8. The control unit 77 is notified of by the measurer 75 that the received optical signal SL includes eight MAC addresses, and determines that the optical fiber bent by the operator is in a section between the 8-branch splitter 51 and the OLT 11. That is, since the service to all the ONUs 21 connected to the 8-branch splitter 51 is stopped when the optical fiber currently being inspected (which leaks the optical signal SL) is cut, the control unit 77 causes the display unit 76 to display “Do not cut.”

### Embodiment 2

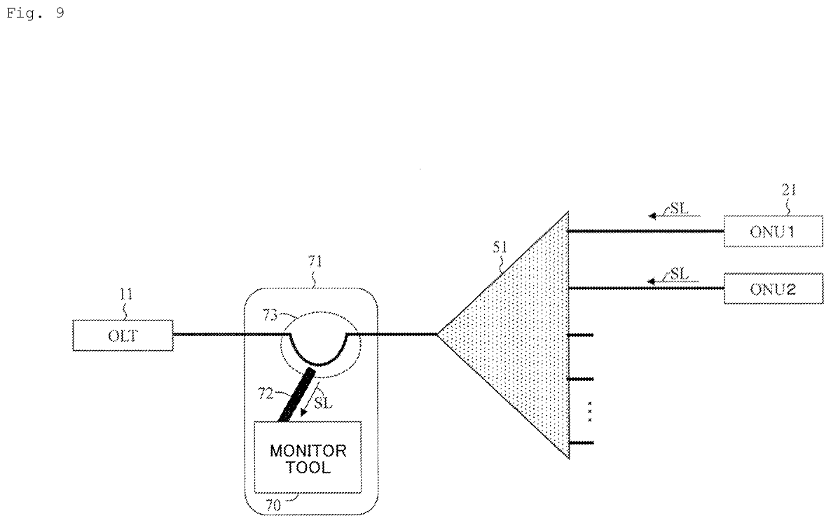

FIG. 9 is a diagram illustrating an optical fiber identification method. In the present embodiment, the optical network in which the OLT 11 and the ONU 21 are connected by the 8-branch splitter 51 will be described. In the present embodiment, two ONUs 21 are connected to the 8-branch splitter 51.

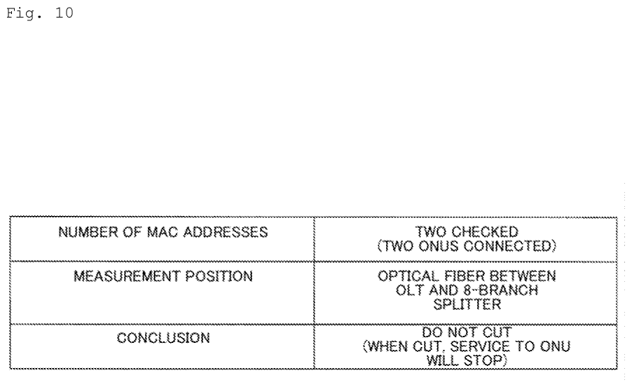

FIG. 10 is a diagram illustrating a display example displayed by the display unit 76. In the present embodiment, two ONUs 21 are connected to the branch splitter 51, and the optical signal SL received by the light receiver 74 includes two MAC addresses. Therefore, the display unit 76 performs display as shown in FIG. 10. The control unit 77 is notified of by the measurer 75 that the received optical signal SL includes two MAC addresses, and determines that the optical fiber bent by the operator is in a section between the 8-branch splitter 51 and the OLT 11. That is, since the service to all the ONUs 21 connected to the 8-branch splitter 51 is stopped when the optical fiber currently being inspected (which leaks the optical signal SL) is cut, the control unit 77 causes the display unit 76 to display “Do not cut.”

### Embodiment 3

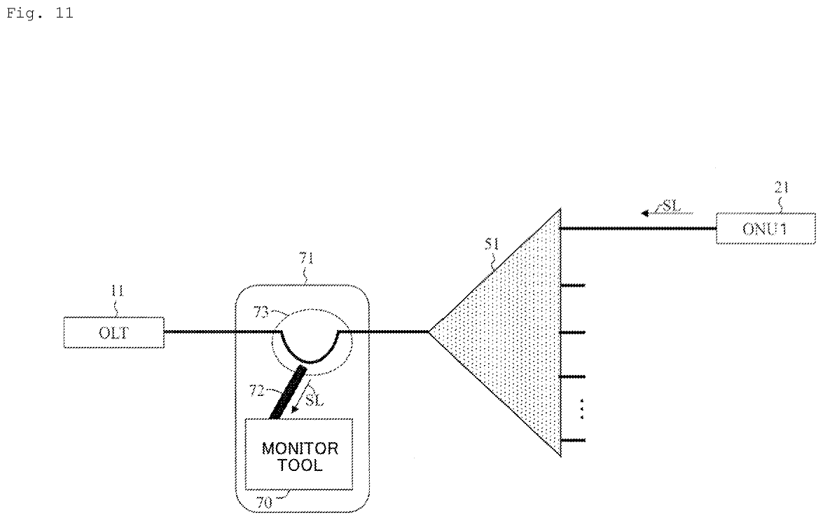

FIG. 11 is a diagram illustrating an optical fiber identification method. In the present embodiment, the optical network in which the OLT 11 and the ONU 21 are connected by the 8-branch splitter 51 will be described. In the present embodiment, one ONU 21 is connected to the 8-branch splitter 51.

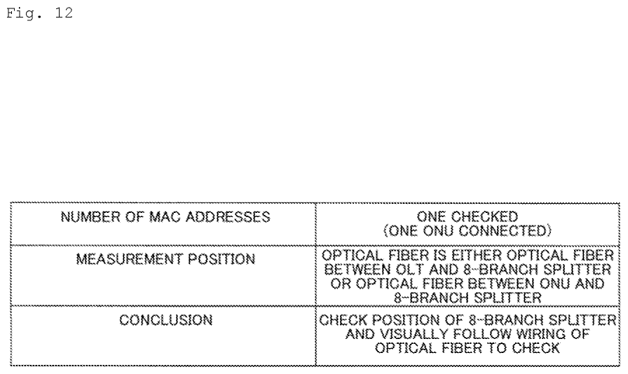

FIG. 12 is a diagram illustrating a display example displayed by the display unit 76. In the present embodiment, one ONU 21 is connected to the branch splitter 51, and one MAC address is included in the optical signal SL received by the light receiver 74. Therefore, an optical fiber bent by an operator is either between the OLT 11 and the 8-branch splitter 51 or between the ONU 21 and the 8-branch splitter 51. Then, the control unit 77 causes the display unit 76 to display the optical fiber so that the operator can visually check the optical fiber. The monitoring device 71 issues an instruction of visual check, thereby preventing a disconnection accident.

### Embodiment 4

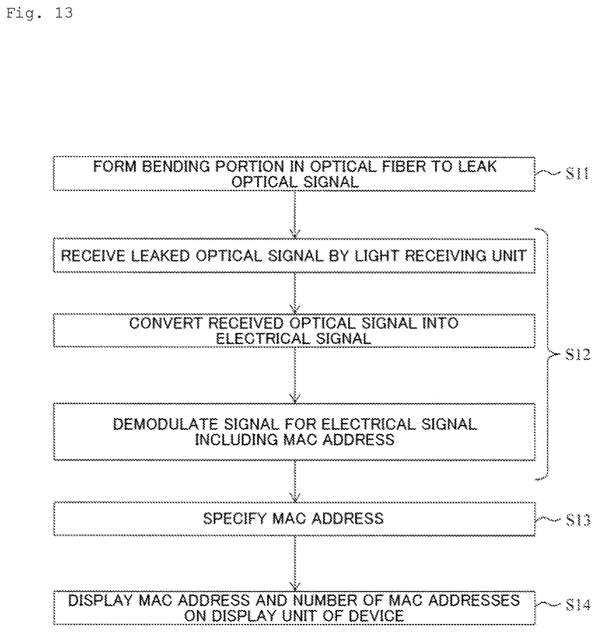

FIG. 13 is a flowchart illustrating an optical fiber identification method performed by the monitoring device 71. The optical fiber identification method includes:
forming a bending portion in the optical fiber when the optical signal SL has leaked from an optical fiber (step S11); receiving the optical signal SL leaked from the optical fiber (step S12);
counting the number of unique numbers (MAC addresses) indicating transmission sources included in the optical signal SL (step S13); and
displaying the number of unique numbers on the display unit 76 (step S14).

An optical signal output from the ONU 21 passes through an optical fiber and reaches the OLT 11 of the communication building. When the optical fiber is bent by the monitoring device 71 on the way, a part of the optical signal propagating through the optical fiber leaks to the outside of the optical fiber.

The monitoring device 71 includes a light receiving unit 74, and the optical signal SL is received by the reception unit 74. Examples of the light receiving unit 74 include an avalanche photodiode (APD). In APD, the optical signal SL is converted into an electrical signal. However, the electrical signal is encrypted, and the MAC address cannot be displayed at this point in time. Then, the light receiving unit 74 demodulates the electrical signal including the MAC address. The MAC address allocated to the ONU 21 can be checked by demodulation of the electrical signal. The control unit 77 causes the display unit 76 to display the MAC address. Further, since the measurer 75 measures the number of MAC addresses included in the optical signal SL, the control unit 77 causes the display unit 76 to display the number of MAC addresses together. This is because the number of MAC addresses is more important than the MAC address number as the information to be notified to the operator.

The operator can identify the optical fiber by advancing the operation according to the flow of FIG. 14 in accordance with the number of MAC addresses displayed on the display unit 76, and can avoid erroneous construction. The flow of FIG. 14 may be determined by the control unit 77 and displayed on the display unit 76 instead of the determination by the operator.

FIG. 14 is a diagram illustrating a method for analyzing the uplink optical signal SL from the ONU 21 and identifying the position of the optical fiber from the number of MAC addresses.

The method includes causing the display unit 76 to display that a portion where the optical signal SL has leaked is between the 8-branch splitter 51 and the OLT 11 when the number of unique numbers (MAC addresses) is two or more, and causing the display unit 76 to display that it is unknown whether a portion where the optical signal SL has leaked is between the 8-branch splitter 51 and the OLT 11 or between the 8-branch splitter 51 and the ONU 21 when the number of unique numbers is one.

The flow of FIG. 14 is a flow performed after step S14 of FIG. 13. First, the operator or the control unit 77 checks the number of MAC addresses of the ONU 21 (step S21). When the number of MAC addresses is two or more, the operator or the control unit 77 determines that the position where the optical fiber is bent is between the 8-branch splitter 51 and the OLT 11 (step S22).

On the other hand, when the number of MAC addresses is only one, the operator or the control unit 77 cannot determine whether the position where the optical fiber is bent is between the 8-branch splitter 51 and the OLT 11 (step S22) or between the 8-branch splitter 51 and the ONU 21 (step S24). Therefore, the operator identifies the position by visually checking the optical fiber. Alternatively, the control unit 77 causes the display unit 76 to display the content described with reference to FIG. 12, and urges the operator to visually check the optical fiber (step S23). By the operator performing visual check, it can be identified whether the position is step S22 or step S24.

The optical fiber identification method using the monitoring device 71 can easily and surely identify the position of the optical fiber to be constructed by following the determination criteria as shown in FIG. 14.

### OTHER EMBODIMENTS

The monitoring device 71 described in the above embodiments can also be realized by a computer and a program, and the program can be recorded in a recording medium or provided through a network.

### REFERENCE SIGNS LIST

10 Communication building
11 OLT
12 IDM
20 User's house
21 ONU
50 Optical cable
51 Optical splitter (8-branch splitter)
52 Closure
53 Tray
54 Frame
55 Utility pole
60 Optical fiber
70 Monitor tool
71 Monitoring device
72 Probe
73 Bending imparting portion
74 Light receiver
75 Measurer
76 Display unit
77 Control unit

1. A monitoring device comprising:
a light receiver that receives an optical signal leaked from an optical fiber;
a counter that counts the number of unique numbers indicating transmission sources included in the optical signal; and
a display unit that displays the number of unique numbers.

2. The monitoring device according to claim 1,
wherein the optical fiber is an optical fiber included in a passive optical network (PON) in which one optical line terminal (OLT) and a plurality of optical network units (ONUs) are connected via an optical splitter,
the light receiver receives the optical signal transmitted by the ONU, and
the monitoring device further comprises a control unit that causes the display unit to display that a portion where the optical signal has leaked is between the optical splitter and the OLT when the number of unique numbers is two or more, and
that causes the display unit to display that it is unknown whether a portion where the optical signal has leaked is between the optical splitter and the OLT or between the optical splitter and the ONU when the number of unique numbers is one.

3. The monitoring device according to claim 1, further comprising a bending imparting portion that forms a bending portion in the optical fiber, the bending portion causing the optical signal to leak from the optical fiber.

4. An optical fiber identification method comprising:
receiving an optical signal leaked from an optical fiber;
counting the number of unique numbers indicating transmission sources included in the optical signal; and
displaying the number of unique numbers on a display unit.

5. The optical fiber identification method according to claim 4, wherein the optical fiber is an optical fiber included in a passive optical network (PON) in which one optical line terminal (OLT) and a plurality of optical network units (ONUs) are connected via an optical splitter,
the optical signal is transmitted from the ONU, and
the optical fiber identification method further comprises causing the display unit to display that a portion where the optical signal has leaked is between the optical splitter and the OLT when the number of unique numbers is two or more, and
causing the display unit to display that it is unknown whether a portion where the optical signal has leaked is between the optical splitter and the OLT or between the optical splitter and the ONU when the number of unique numbers is one.

6. The optical fiber identification method according to claim 4, further comprising forming a bending portion in the optical fiber when the optical signal has leaked from the optical fiber.
